(19) United States
(12) Patent Application Publication
(10) Pub. No.: US 2014/0218904 A1
(43) Pub. Date: Aug. 7, 2014

(54) CLIP ON SAFETY LIGHT DEVICE

(71) Applicant: Paul E. Cayton, New York, NY (US)

(72) Inventor: Paul E. Cayton, New York, NY (US)

(21) Appl. No.: 13/760,216

(22) Filed: Feb. 6, 2013

(51) Int. Cl. F21L 4/00

(52) U.S. Cl. CPC F21L 4/00
USPC 362/191

(57) ABSTRACT

A small, lightweight, illuminable, wearable, clip-on safety light device that resembles a decorative seasonal or ornamental attachment to apparel or personal items which incorporates a series of LED's or other means of producing bright light capable of being operated through multiple modes of operation, such as sequential, random, continuous, and the like. The light is capable of being seen a distance away from the wearer, and will draw the attention of the human eye, thereby making the wearer more visible at night or in low light conditions.

### BACKGROUND OF THE INVENTION

The present invention is directed to an illuminable, wearable, clip-on safety light device designed to be worn on-the-person, such as on clothing, the wrist, neck, and the like. The device may also be clipped onto bags, personal items and other objects. The clip-on safety light device may be styled to serve as a bracelet, necklace, ring, pin, broach, tag, or other decorative item, and include one or more bright lights, provided by LED's or other light sources. The lights may be designed to provide multiple colors or changes of color, or with different modes of operation, such as steady, flashing, or other patterns, or a combination thereof. The lights are programmed so that they can be seen from a distance away from the wearer, and draw the attention of the human eye.

Notably, the increasing development and use of mobile cell phones, child monitors, etc., have had a significant impact on individual safety. Many devices have been developed to improve the safety of individuals, particularly children, participating in crowded events, holiday activities, or night activities. However, there is an unmet need for a device which will provide greater visibility to children who are pursuing activities at twilight, at night, in crowds, or during darker seasons of the year.

Activities such as trick-or-treating on Halloween provide considerable enjoyment to children, but also create dangers because the children participating in such activities are often distracted. This result is children that get lost in large crowds of strangers. There is also risk that, especially during late afternoon and evening hours, due to the darkness of the light, that children may not be readily visible. Such poor visibility presents a serious danger, which can result in death or injury, as attentive or inattentive motor vehicle drivers may accidentally hit a child who is not readily visible.

U.S. Pat. No. 6,611,244 disclose a small, illuminated, wearable-safety device or item that may also serve as an item of jewelry or ornamental apparel attachment. The device incorporates a series of LED's packages, with each LED package being made of three individual LED's, one of blue, one of green, and one of red, whereby a continuous range of colors may be emitted by energizing of each individual LED of the LED package sequentially. The LED packages are capable of being flashed in various modes of operation, such as sequential, random, continuous, and the like. The LED packages are also controlled where the colors emitted by each LED package may be altered according to a fixed or random pattern, all of which are controlled by a microprocessor.

U.S. Pat. No. 8,269,654 discloses a flashing beacon that may include a signal unit, a control unit associated with the signal unit, a solar panel or collector, and an activation device that may all be mounted or otherwise positioned on a post of a roadway sign. Light units associated with the signal unit may be programmed to flash on and off in a unique wig-wag pattern. Further, a light bar may also be used with the beacon to generate an intense flash of light soon after activation of the beacon as an additional means of grabbing the attention of the operator of a vehicle.

U.S. Pat. No. 8,298,028 discloses a personal visibility mark that may increase the visibility of a person in the water to operators of watercraft and may be used in combination with a personal flotation device. The personal visibility mark may include a housing including at least one intake opening. The housing may be removably coupled to a personal flotation device or may be an integral component of the personal flotation device.

U.S. Pat. No. 8,303,129, a dual-ended illumination device that is fastened to a user's wrist is disclosed, comprising a small cylindrical flashlight having a first end with at least three (3) white light-emitting diodes (LED's) and a second end having at least one (1) red LED. A four position switch located at a midpoint on the housing provides for OFF-WHITE-RED-BOTH positions. The flashlight attaches to one's wrist by use of a nylon strap secured with a fastening means. It is positioned on either the inside or outside of the wrist to suit a desired illumination need.

The present invention is directed to a clip-on safety light device that will make a child easily seen by their parents, by others, and by vehicle motorists. The invention can be attached to a belt, a school bag, a bracelet, or other objects where it can clip-on. The invention is intended to be of low weight, and may be attractively designed in the shape of a holiday-themed object, an animal or insect, or a well-known cultural icon, such as a comic book character, a television cartoon character, or another popular image that is enjoyed by younger children. The invention is also of use during the seasons of the year when daylight hours are shorter, when children are often outdoors at dusk. By combining an attractive design with bright lights and customizability as to where the invention may be worn, the invention is designed to appeal to children as both a fashionable and “cool” item to wear, while also satisfying the needs of parents to protect their child. The invention may also be of value for adults working in difficult and dangerous circumstances at night or in darkness, such as bicycle riders, runners, road workers, firemen and other emergency service workers. Further, the invention may be useful for providing visibility to pets, and can be designed to clip-on to dog and cat collars.

### SUMMARY OF THE INVENTION

It is the primary object of the present invention to provide a relatively small, lightweight, illuminable, wearable, clip-on safety light device that may serve as an ornamental attachment to apparel or personal items, or to pets, which incorporates one or more light sources, whereby a range of patterned and/or flashing lights may be emitted in a manner designed to catch the human eye.

It is another primary object of the present invention to provide such a relatively small, lightweight, illuminated, wearable, clip-on safety light device or item that may also serve as an ornamental attachment to apparel or personal items which incorporates one or more light sources, whereby a range of patterned and/or flashing lights may be emitted in various modes of operation, such as sequential, random, continuous, and the like, and where the colors emitted by each light source may be controlled according to a fixed or random pattern, to be seen from a distance away from the wearer, and designed to catch the human eye.

### BRIEF DESCRIPTION OF THE DRAWINGS

The above and other objects and advantages of the invention will be apparent upon consideration of the following detailed description, taken in conjunction with the accompanying figures, in which like reference characters refer to like parts throughout, and in which:

FIG. 1 is an exploded view of the clip-on safety light device, according to one preferred embodiment of the present invention;

FIG. 2 is the reverse exploded view of the clip-on safety light device, according to one preferred embodiment of the present invention; and

FIG. 3 is a view of the clip-on safety device in position for use, according to one preferred embodiment of the present invention.

### DETAILED DESCRIPTION OF THE EXEMPLARY EMBODIMENTS

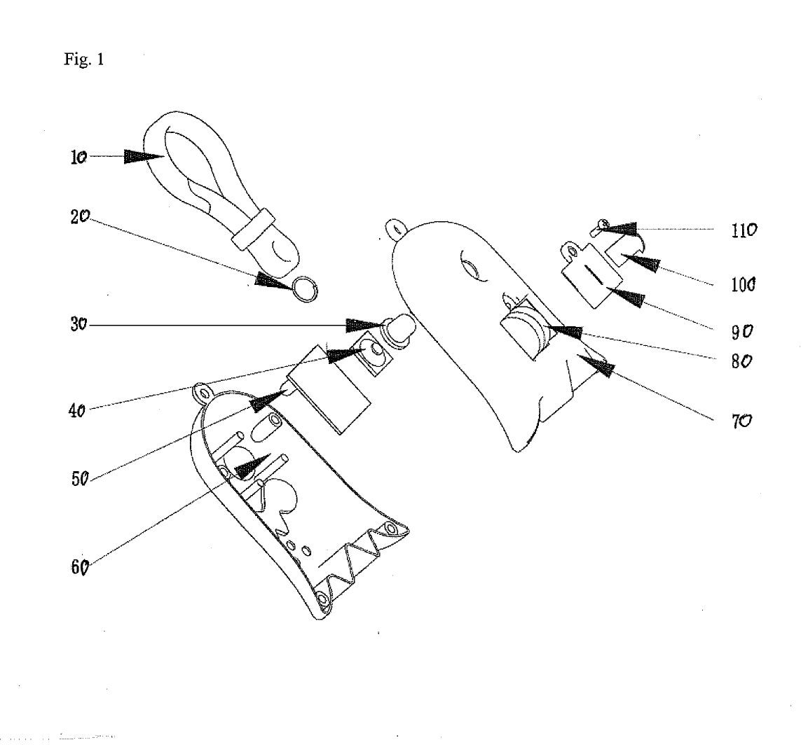

One mode for carrying out the invention is presented in terms of its preferred embodiment, herein depicted within FIGS. 1 through 3. However, the invention is not limited to the described embodiment and a person skilled in the art will appreciate that many other embodiments of the invention are possible without deviating from the basic concept of the invention, and that any such work around will also fall under scope of this invention. It is envisioned that other styles and configurations of the present invention can be easily incorporated into the teachings of the present invention, and only one particular configuration shall be shown and described for purposes of clarity and disclosure and not by way of limitation of scope.

Headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). The terms “a” and “an” herein do not denote a limitation of quantity, but rather denote the presence of at least one of the referenced items.

Referring now to FIG. 1, an exploded view of the clip-on safety light device is disclosed, according to the preferred embodiment of the present invention. The device may be clipped on to apparel or personal items using a hanging buckle which is designed to have a flexible but secure clip (10). This hanging buckle is in turn attached to a ring (20). This ring is then attached to an enclosure which is formed by a front cover (60) and a back cover (70) when the covers are joined together. Covers are designed to be capable of being snapped or adhered together in a manner well-known in the art. The enclosure could be designed to resemble a seasonal theme or recognizable cultural icon. The front and back covers can be made of impact-resistant plastic, although other transparent or translucent materials such as fiberglass and the like could also be used with equal effectiveness. The thickness of the enclosure is such that it protects the light source and related electronics, but also permits the light inside the enclosure to be seen outside the enclosure and does not inhibit the eye-catching nature of the light source. The enclosure houses light modules such as one or more light-emitting diodes (LED's) (5) arranged such that the emitted light from the light-emitting diodes (LED's) is projected outwards through the walls of the enclosure. The enclosure also houses the electronic control unit or key (40) which controls the mode and operation of the light source. The back cover has a hole in it that provides space for a control switch, such as a push button mechanism comprising a key cover (30) and key (40) which may be used to turn on the light source and set the mode of the electronic control unit. Other means of turning on the device may be employed. As a power source, batteries (80) for the device are housed within the back cover. The type of batteries used for the device is not limiting and depends on the lighting device employed and the intended use. The batteries may be positioned between the walls of the enclosure, or within a compartment formed in one of the enclosure walls. If positioned in a compartment, they are enclosed in a battery case cover (90), which is held in place by a screw (110) which fits into and through the battery case cover and secures it to the back cover of the enclosure. Depending on the preferred design, the power source of the device may be rechargeable or replaceable.

For the purpose of shipping, display and sale, the electric circuit of the device is broken by an insulating strip (100) inserted into the battery case whilst in packaging. The insulating strip serves as a one-time removable tab from the battery case, which keeps the batteries disconnected until removed so as to prevent the light source from being turned on accidentally while still in packaging. The position of the insulating strip is not limiting on the invention.

In addition to use for seasonal celebrations, examples of the device in action include the use of the clip-on safety light device for use while walking, running, riding a bicycle, including, for example, during diminished light or at night. Other uses could include use by firefighters, law enforcement officers who may be responding to a traffic condition, or emergency workers working in a roadway or elsewhere where it is important that oncoming vehicles are aware of their presence or that other workers can see them. It could also be used on job sites and construction sites to illuminate the presence of fellow workers in dim or dark lighting conditions. The exact configuration of the flashing light patterns and colors utilized may be varied to suit the application and wearer of the clip-on safety light device.

The clip-on safety light device may also be used as a pet safety tag, for example, by attachment to a dog collar or leash. This will enable greater visibility for pets which, for example, may be prone to dashing out in front of traffic. The clip may be attached directly to the enclosure, or attached to a ring attached to the enclosure, or by any other suitable means of attachment to the enclosure known to one of ordinary skill in the art.

The clip-on safety light device may be mounted directly to apparel, to the zipper of an item of apparel, or personal items carried by the user, such as a backpack. It may also be attached to objects, such as a bicycle or stroller. The device is attached by the use of a flexible clip (10) attached to the enclosure. Other suitable attachment means include a plastic clip attached via a key-ring to the light device, a sliding clip, a key ring-style fastener, knotable cords, velcro snaps, etc. The ring (20) serves as a spacer to ensure that the enclosure is positioned so as to hang prominently and freely from the apparel or personal item, thus permitting no blockage of the light sources to occur from the user's arm, shirt, jacket or coat. The clip should most likely be made of durable material such as plastic or aluminum which will withstand some activity and physical elements such as ultraviolet (UV) radiation, water, abrasion, and the like. The ring may be made of plastic, aluminum or other suitable material. The flexible clip may be designed so that it can be manipulated and attached by a child, for example by making the clip larger in size. For safety, and to ensure that a child does not manipulate the device, the clip may also be designed so that it is smaller or stronger, thereby making it difficult for a child to operate.

The battery compartment may be externally or internally accessible dependent on the preferred design. A back cover may be provided which opens into the enclosure to provide access to a battery compartment which houses user replaceable batteries. The use of light-emitting diodes (LED's) ensures low power draw and long operating life between replacements of the battery. The outer design of the invention may also be waterproof to withstand wear in all weather conditions. Finally, a control switch is located on the back of the enclosure. The preferred control switch is envisioned to be of a push button design that provides for OFF-ON positions, and for light mode selection, for ease of use by either parents or children.

Neither the push button nor binary nature of the control of the light source is considered limiting to the invention. For example, the light could include various modes, such as a continuous ON mode, or a sequential mode, including multiple colors. A flashing light source provides an eye-catching illumination in all directions. Additionally, alternating colors such as red and blue may also be used in a steady, color changing mode, or a flashing mode. Such flashing ability would be provided by a flashing module (not seen in this configuration).

The light source may be an LED light, containing more than one LEDs. For example, the light may consist of three different LEDs, so as to provide a light source capable of providing multiple colors. The light circuitry may provide for selection of a single color, a series of sequentially changing colors, a specific light pattern, such as a flashing pattern, a series of changing patterns, or a combination of any of the foregoing. The light energizes in response to the pressing of a selector switch positioned external to the enclosure, so that the user may control when the light is on or off, and may select from different lighting modes provided by the light circuitry. The selector switch is positioned so that it protrudes from the outer surface of the enclosure, which enables the user, including a child to readily manipulate the selector switch to control the function of the light.

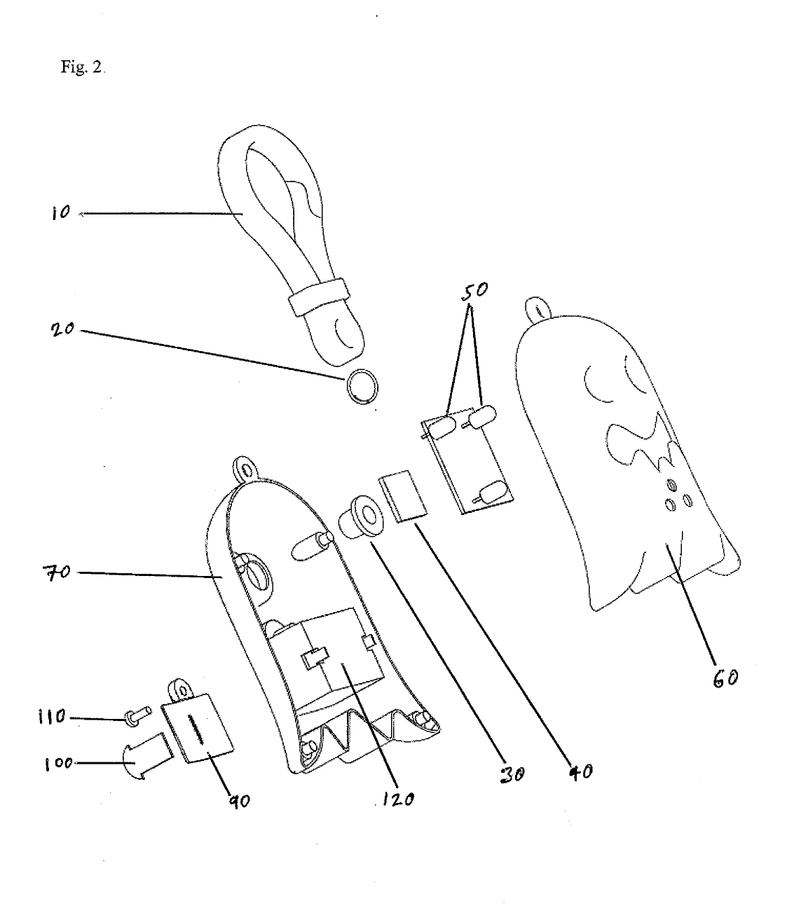

Referring next to FIG. 2, a reverse exploded view of the clip-on light safety device is depicted. This view shows the battery case (120) housed within the back cover of the enclosure. This view also shows that one or more light sources, such as LED's (50), may be used. The clip-on safety light device can be located anywhere upon a belt or belt loop, or a personal item so that it is convenient to line of sight according to the discretion of the user. One simply adjusts the clip attached to the enclosure to position it anywhere as needed to produce the appropriate light pattern. Additionally, it can be placed on a container strap, bag straps, outer coat button holes, hair clips, etc. Positions can be selected by the user according to whether the activity engaged in is biking, walking or jogging, with the light sources illuminated to serve as a warning light to others. The clip-on safety light device would be most likely used with a flashing module (as shown in FIGS. 1-2). The device is viewed as being especially valuable in crowded areas where it is difficult to keep track of younger children. It is also viewed as a useful tool or implement that would help ensure that children are visible at dusk or during the night.

Power for the clip-on safety light device is provided by a set of batteries connected to the lights via the control switch. The control switch prevents the flow of electricity to the light-emitting diodes (LED's) when the control switch is in the “OFF” position. When in the “ON” position, the current will flow to the LEDs. The switch can be activated via a button press, by sliding an actuator, by direct contact with the user's finger, or via other mechanisms well-known in the art. It should be noted that the circuit described herein is a simple variation of a combination parallel/series circuit and as such, can be designed in different variations by those familiar in the art to achieve the end results. As such, the exact circuit description should not be interpreted as a limiting factor of the present invention. Those skilled in the art will realize that the circuitry may include any one of a number of known integrated circuits which provide functions related to controlling power flow to a light source. Depending on the design of the electronic components, or if a multi-bulb or multifunction light is to be provided, the switch may be configured to act as an on-off switch, a mode selector switch, or a combination thereof. For example, in communication with the integrated circuit, the switch may set the flash rate, color, or brightness of the light source. The switch may be configured to close the circuit, connect the power source to the light source and to select the desired mode or function. Alternatively, the device could include a separate on-off means, and the switch could be configured as a mode selector switch to select the desired light function. The device may also include a selector switch to lock the mode of the light, to prevent a child from altering the setting.

To operate, the user must remove the strip that isolates the internal batteries from this circuit. Next the user would place the clip-on safety light device in the desired location and fasten it in place using the flexible clip on the hanging buckle. Finally, the user would activate the illumination using the control switch to produce the desired, pre-programmed pattern of light from the device. Such activation would depend upon the activating being performed by the user or other supervising third party such as a parent at the specific time. Any changes necessary to the operation of the clip-on safety light device could be made at any point in time by simply pressing the control switch. When completed with the use of the clip-on safety light device, it would be deactivated using the control switch, removed and stored away until needed again. When the set of internal batteries are depleted from use, they can be replaced by the final user allowing usage to continue in an indefinite cyclical pattern.

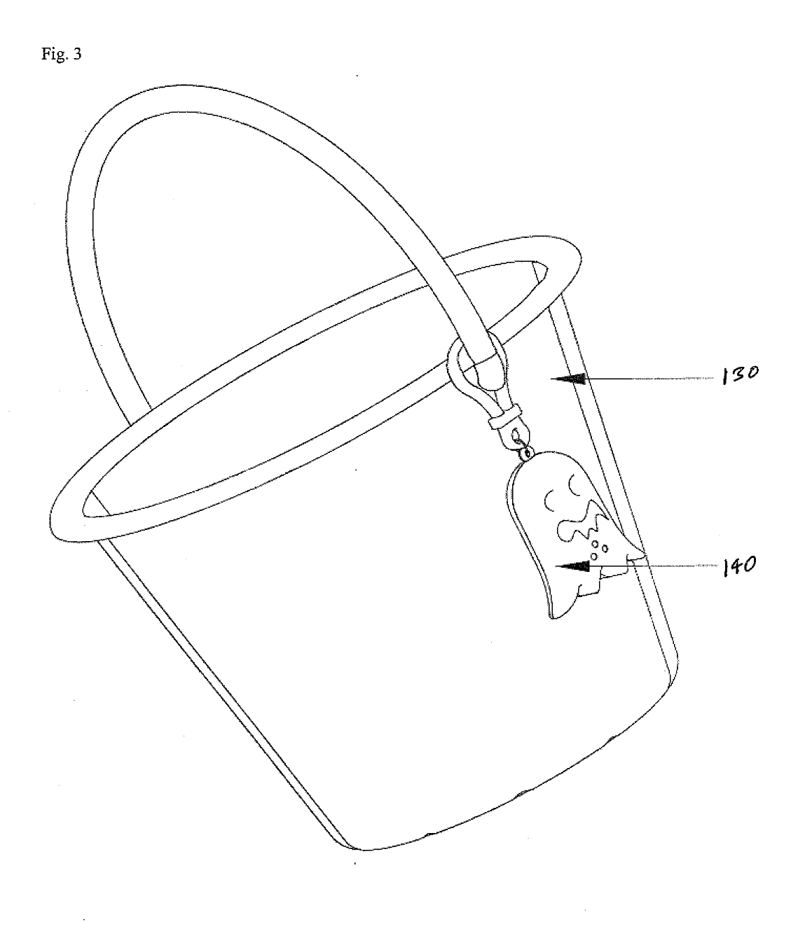

Referring finally, to FIG. 3, a clip-on light safety device, according to the preferred embodiment of the present invention is shown. The device has been clipped to the handle of a barrel (130) which may be used by a child for collecting candy and snacks at Halloween. The device when assembled, so that the front and back covers are joined to form an enclosure, resembles a cultural icon associated with the particular season in the form of an ornamental pendant (140). The specific ornamental design of the device is in no way limiting to the invention. It is envisioned that other styles and configurations of the safety light are within the scope of the present invention. For example, a clip on safety light for use by emergency workers could be less ornamental and more functional in its shape and appearance.

The preferred embodiment of the present invention can be utilized by the common user in a simple and effortless manner with little or no training. It is envisioned that the clip-on safety light device would be constructed in general accordance with FIG. 1 through FIG. 3.

The foregoing descriptions of specific embodiments of the present invention have been presented for purposes of illustration and description. They are not intended to be exhaustive or to limit the invention and method of use to the precise forms disclosed. Obviously many modifications and variations are possible in light of the above teaching. It is understood that various omissions or substitutions of equivalents are contemplated as circumstance may suggest or render expedient, but is intended to cover the application or implementation without departing from the spirit or scope of the claims of the present invention.

What is claimed is:

1. A clip-on safety light device freely positional at the discretion of a user to provide a light pattern, said clip-on safety light device comprising:
an enclosure;
a light source situated within said enclosure;
a power source located at said enclosure;
a control switch electrically coupled to said power source;
and, a light source driver circuit electrically coupled to said power source;
wherein when said control switch is activated said light source cooperates to emit light in multiple directions.

2. The clip-on safety light device of claim 1, further comprising: a ring spacer attached to a surface of said enclosure and a flexible clip attached to said ring spacer, wherein said flexible clip is adapted to freely position said enclosure according to the discretion of the user.

3. The clip-on safety light device of claim 2, wherein said enclosure is adapted to have a shape that comprises the image of a comic book character, television character, film character or a holiday character or object associated with a particular holiday season, such that the enclosure will be recognized by the user as appearing in a distinct image.

4. The clip-on safety light device of claim 1, wherein said enclosure comprises: a battery compartment having a waterproof cover situated within said enclosure; wherein said control switch is located on a side of said enclosure; and, wherein said power source is situated within said battery compartment.

5. The clip-on safety light device of claim 1, wherein said light source provides a flashing action.

6. The clip-on safety light device of claim 1, wherein said light source alternates between different colored lights.

7. The clip-on safety light device of claim 1, wherein said light source comprises one or more light emitting diodes.

8. The clip-on safety light device of claim 1, wherein said control switch is both an on-off switch and a mode selector switch.

9. The clip-on safety light device of claim 8, wherein said mode selector switch cycles through on modes comprising a single color, multi-color, single color flashing, multi-color flashing, and off.

10. A method of utilizing a clip-on safety light device freely positional at the discretion of a user to provide a light pattern, said method comprising the steps of:
providing and positioning a portable enclosure at the discretion of a user;
a light sources situated within said enclosure;
providing and locating a power source at said enclosure;
providing and electrically coupling a control switch to said power source;
providing and electrically coupling a light source driver circuit to said power source;
and, said light source emitting light in multiple directions based upon a position of said control switch.

11. The method of claim 10, wherein said light source provide a flashing action.

12. The method of claim 10, wherein said light source alternates between different colored lights.

13. The method of claim 10, wherein the step of providing and positioning a portable enclosure at the discretion of the user further comprises attaching said enclosure to an article of clothing.

14. The method of claim 13, wherein said article of clothing comprises a child's costume.

15. The method of claim 10, wherein the step of providing and positioning a portable enclosure at the discretion of the user further comprises attaching said enclosure to an object carried by a child.

16. The method of claim 15, wherein said object carried by a child is an article for carrying holiday candy.

17. The method of claim 10, wherein said user attaches the clip-on safety light device to a garment of a pet.
